(19) United States
(12) Patent Application Publication
(10) Pub. No.: US 2005/0036923 A1
(43) Pub. Date: Feb. 17, 2005

(54) End cone construction for catalytic converters and method for making same

(76) Inventors: Ronald S. Brisbin, Holly, MI (US); Keith A. Grable, Clarkston, MI (US); Robert J. DePierre, Clarkston, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/901,339

(22) Filed: Jul. 28, 2004

Related U.S. Application Data
(60) Provisional application No. 60/491,492, filed on Jul. 31, 2003.

(51) Int. Cl. B01D 53/34

(52) U.S. Cl. 422/179; 29/890; 422/177

(57) ABSTRACT

An end cone construction and related method for catalytic converters includes first and second inner and outer cone members, each with a small end, a large end and a continuous imperforate sidewall therebetween. The large ends of the first inner and outer cone members are connected with the small ends of the second inner and outer cone members respectively to create airtight seals, and define inner and outer cone assemblies which are positioned concentrically to define an insulating space therebetween. The small ends of the inner and outer cone assemblies are connected with an exhaust pipe, and the large ends of the inner and outer cone assemblies are connected with a catalytic converter can. A vacuum may be drawn in the insulating space to insulate the inner and outer cone assemblies.

### CROSS-REFERENCE TO RELATED APPLICATION

Applicants hereby claim under 367 CFR 1.78 the benefit of earlier filed, related Provisional Patent Application Ser. No. 60/491,492, filed Jul. 31, 2003, entitled STACKED INLET CONE CONSTRUCTION FOR CATALYTIC CONVERTERS.

### BACKGROUND OF THE INVENTION

The present invention relates to catalytic converters, and in particular to an end cone construction therefor, and related method for making the same.

PCT Patent Publications WO 00/43103, WO 00/43104 and WO 00/43105, which are commonly assigned, and hereby incorporated herein by reference, disclose a unique vacuum insulated catalytic converter. The subject catalytic converters include a centrally located catalyst through which exhaust gases pass, an inner housing which surrounds the catalyst, and an outer housing which surrounds the inner housing. A vacuum cavity is formed between the inner housing and the outer housing, and serves to insulate the catalyst to maximize the time the catalytic material is within its optimum temperature operating range.

U.S. Pat. No. 6,001,314 to Buck et al discloses a catalytic converter housing with deep drawn shells. In the Buck et al catalytic converter, two clamshell cones are welded along the axis of the cone.

### SUMMARY OF THE INVENTION

One aspect of the present invention is a method for making an insulated end cap for catalytic converters and the like of the type having a housing member and a substrate support member. The method includes forming first and second inner and outer cone members, each with a small end, a large end and a continuous imperforate sidewall therebetween, and connecting the large ends of the first inner and outer cone members with the small ends of the second inner and outer cone members respectively to create airtight seals, and define inner and outer cone assemblies, which are positioned concentrically to define an insulating space therebetween. The method further includes connecting the small ends of the inner and outer cone assemblies with an exhaust pipe, and the large ends of the inner and outer cone assemblies with a catalytic converter can. Finally, the method includes drawing at least a partial vacuum in the insulating space to insulate the inner cone assembly from the outer cone assembly.

Another aspect of the present invention is a method for making vacuum insulated end caps for catalytic converters and the like of the type having a housing member and a substrate support member. The method includes forming first and second inner and outer cone members, each with a small end, a large end and a continuous imperforate sidewall therebetween, and connecting the large ends of the first inner and outer cone members with the small ends of the second inner and outer cone members respectively to create airtight seals, and define inner and outer cone assemblies, which are positioned concentrically to define an insulating space therebetween. The method further includes connecting the small ends of the inner and outer cone assemblies with an exhaust pipe, and the large ends of the inner and outer cone assemblies with a catalytic converter can. Finally, the method includes drawing at least a partial vacuum in the insulating space to insulate the inner cone assembly from the outer cone assembly.

Yet another aspect of the present invention comprises a catalytic converter of the type having a housing and a substrate support member, as well as an improved vacuum insulated end cap, comprising first and second inner and outer cone members, each with a small end, a large end and a continuous imperforate sidewall therebetween. The large ends of the first inner and outer cone members are connected with the small ends of the second inner and outer cone members respectively to create airtight seals, and define inner and outer cone assemblies, which are positioned concentrically to define an insulating space therebetween. The small ends of the inner and outer cone assemblies are connected with an exhaust pipe, and the large ends of the inner and outer cone assemblies are connected with a catalytic converter can. The insulating space contains at least a partial vacuum to insulate the inner cone assembly from the outer cone assembly.

Yet another aspect of the present invention comprises a method for making catalytic converters and the like of the type having a housing member, a substrate support member and opposite end caps. The method includes forming first, second and third inner and outer cone members, each with a small end, a large end and a continuous imperforate sidewall therebetween. The large ends of the first inner and outer cone members are connected with the small ends of the second inner and outer cone members respectively to create airtight seals. The large ends of the second inner and outer cone members are connected with the small ends of the third inner and outer cone members respectively to create airtight seals, and define inner and outer cone assemblies, which are positioned concentrically to define an insulating space therebetween. The small ends of the inner and outer cone assemblies are connected with an exhaust pipe, and the large ends of the inner and outer cone assemblies are connected with a catalytic converter can.

Yet another aspect of the present invention is an end cone construction for catalytic converters and the like, and a related method which allows more complex shapes to be manufactured more easily, and for better dimensional control of the gas flow surfaces. The complex shapes allow for better utilization of the catalyst and lower pressure drop across the catalyst assembly. The assembly comprises two or more generally cone-shaped members that are welded or otherwise interconnected to form a more complex shaped cone. A weld is preferably formed around the circumference of the cone, as compared to clamshell cones that are welded along the axis of the cone.

The present invention is efficient in use, economical to manufacture, capable of a long operating life, and particularly well adapted for the proposed use.

These and other advantages of the invention will be further understood and appreciated by those skilled in the art by reference to the following specification, claims and appended drawings.

### BRIEF DESCRIPTION OF THE DRAWINGS

FIG. 1 is a cross-sectional view of an end cone construction for catalytic converters embodying the present invention, taken along a longitudinal axis thereof, and shown connected with an exhaust pipe and a catalytic converter can.

FIG. 2 is a cross-sectional view of another embodiment of the present invention, taken along a longitudinal axis thereof, and shown connected with an exhaust pipe and a catalytic converter can.

FIG. 3 is a cross-sectional view of yet another embodiment of the present invention, taken along a longitudinal axis thereof, and shown with an exhaust pipe.

### DETAILED DESCRIPTION OF THE PREFERRED EMBODIMENTS

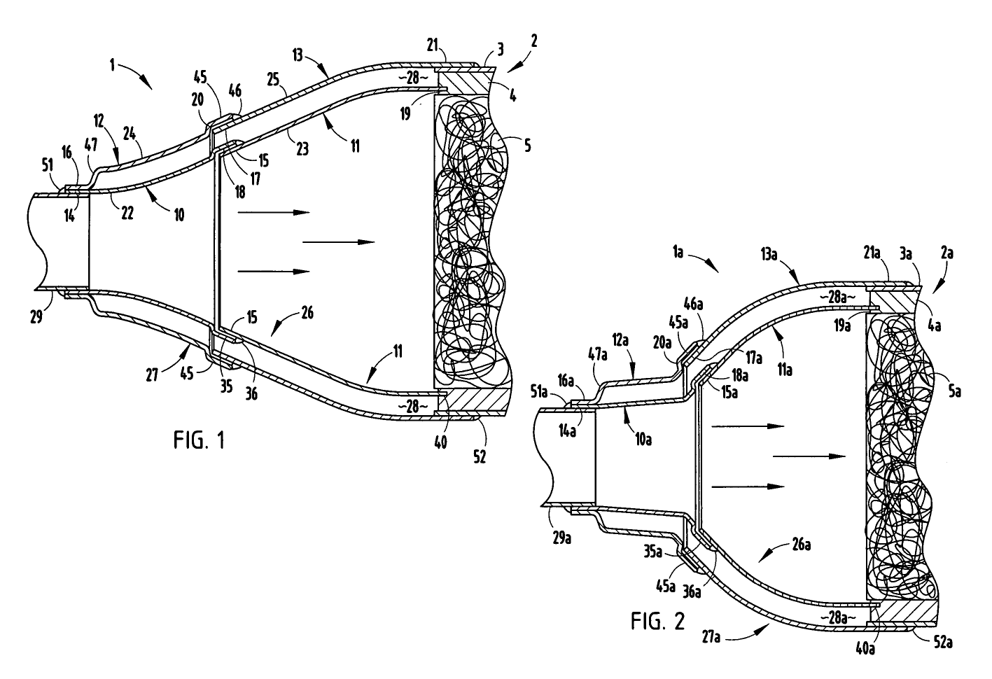

For purposes of description herein, the terms “upper”, “lower”, “right”, “left”, “rear”, “front”, “vertical”, “horizontal” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts disclosed herein. Hence, specific dimensions and other physical characteristics relating to the embodiments disclosed herein are not to be considered as limiting.

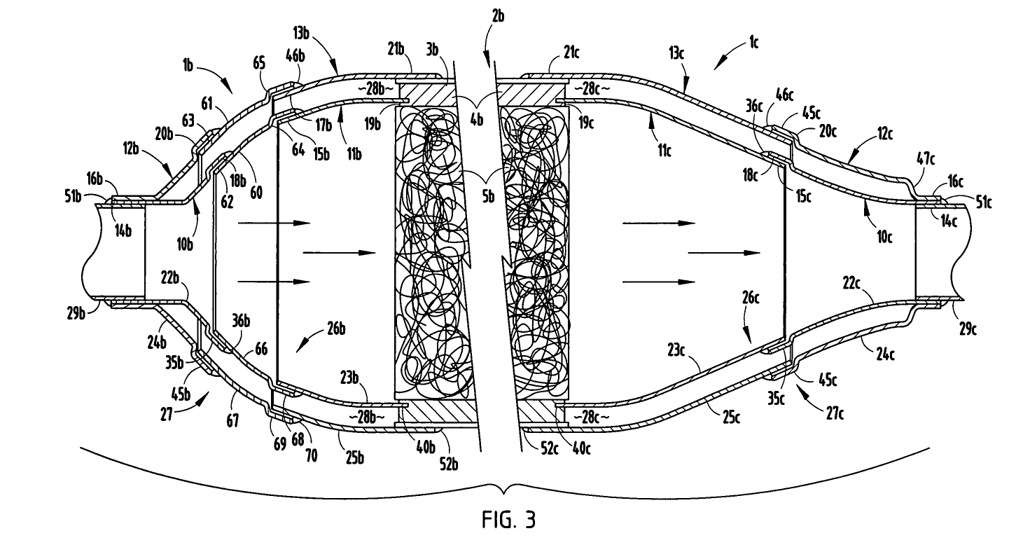

The reference numeral 1 (FIG. 1) generally designates an end cone construction embodying the present invention. End cone construction 1 is designed for use in conjunction with the illustrated catalytic converter 2, which includes a can or housing member 3 and a substrate support member 4 in which a substrate or catalyst 5 is retained. In the example illustrated in FIG. 1, end cone construction 1 is shown attached to the inlet end of catalytic converter 2. However, it is to be understood that end cone construction 1 may also be attached to the opposite or outlet end of catalytic converter 2, as shown in FIG. 3.

The end cone construction illustrated in FIG. 1 includes first and second inner and outer cone members 10-13 respectively, each with a small end 14-17, a large end 18-21 and a continuous imperforate sidewall 22-25 therebetween. The large ends 18 and 20 of first inner and outer cone members 10 and 12 are connected with the small ends 15 and 17 of second inner and outer cone members 11 and 13 respectively to create airtight seals, and define inner and outer cone assemblies 26 and 27 respectively, which are positioned concentrically to define an insulating space 28 therebetween. The small ends 14, 16 of inner and outer cone assemblies 26 and 27 are connected with an exhaust conduit or pipe 29, and the large ends 19, 21 of inner and outer cone assemblies 26 and 27 are connected with the can portion of catalytic converter 2, which in the illustrated example, includes housing member 3 and substrate support member 4. In at least one embodiment of the present invention, a vacuum is drawn in insulating space 28 to thermally insulate inner and outer cone assemblies 26 and 27.

In the example illustrated in FIG. 1, first inner cone member 10 has a generally conoidal shape, and includes a radially enlarged seat or socket 35 with a size and shape which closely receive the small end 15 of second inner cone member 11 therein. A circumferential weld 36 extends completely around the outside surface of second inner cone member 11 and the end edge of large end 18 to create an airtight seal. Sidewall 22 is generally curved or arcuate in shape, and flares radially outwardly from small end 14 to large end 18.

Second inner cone member 11 also has a generally conoidal shape, and tapers radially outwardly from small end 15 to large end 19. As noted above, the small end 15 of second inner cone 11 is closely received within the socket 35 of first inner cone member 10. The large end 19 of second inner cone member 11 is received in a slot 40 in the end of substrate support 4 and creates an airtight seal therewith. Second inner cone 11 has a generally bell-shaped configuration, with a relatively straight conic section toward small end 15, and a curved section toward large end 19, which bends in a direction opposite first inner cone member 10, such that large end 19 lies in a plane generally parallel with the central axis of catalytic converter 2.

First outer cone member 12 includes a radially enlarged seat or socket 45 at the large end 20 of first outer cone member 12, which is sized and shaped to closely receive the small end 17 of second outer cone member 13 closely therein. A circumferential weld 46 extends around the free end edge of socket 45 and the outer surface of the second inner cone member 11 adjacent the small end 15 thereof to create an airtight seal. Socket 45 is generally similar in construction to the previously describe socket 35 on first inner cone member 10. First outer cone member 12 also has a generally curved or arcuate configuration, which flares radially outwardly from small end 16 to large end 20. First outer cone member 12 has a radially inwardly tapered step or neck portion 47, which transitions from first outer cone member 12 to the small end 14 of first inner cone member 10, thereby sealing off the end of the insulating space 28 between first inner cone member 10 and first outer cone member 12.

Second outer cone member 13 is similar in configuration to second inner cone member 11, and tapers radially outwardly from small end 17 to large end 21. Like second inner cone member 11, second outer cone member 13 has a generally bell-shaped configuration with a conical portion adjacent small end 17, and an inwardly curved portion adjacent large end 21, which lies in a plane generally parallel with the central axis of catalytic converter 2. The small end 17 of second outer cone member 13 is closely received within the socket 45 of first outer cone member 12, and the large end 21 of second outer cone member 13 is closely received over the outer surface of housing member 3 and attached thereto by means such as welding or the like to create an airtight seal therebetween.

In at least one embodiment of the present invention, cone members 10-13 are formed from metal into their illustrated, generally conoidal shape. Cone members 10-13 may be formed from high strength steel by means such as stamping from a sheet, spun form, extruded, or made from formed tubing, or by means such as hydroforming or the like. Ferritic and austenitic stainless steel grade materials are suitable for such applications. It is contemplated that a plurality of differently sized and shaped cone members 10-13 will be formed and inventoried, so as to permit an assembler to create a wide variety of complex shapes using the pre-formed cone members, as discussed in greater detail hereinafter. After cone members 10-13 are formed, they are assembled in an axially stacked relationship. More specifically, in the example illustrated in FIG. 1, the small end 15 of second inner cone member 11 is inserted into the socket 35 of first inner cone member 10, and is closely received therein. Circumferential weld 36 is then formed around the free end edge of socket 35 and the adjacent exterior surface of second inner cone member 11 to create an airtight seal therebetween, and thereby define inner cone assembly 26. First outer cone member 12 and second outer cone member 13 are assembled and interconnected in a similar manner to define outer cone assembly 27. Inner cone assembly 26 is then inserted into outer cone assembly 27, so that the same assume a generally coaxial relationship, as shown in FIG. 1. The outer surface of the small end 14 of inner cone assembly 26 abuts closely with the interior surface of the small end 16 of outer cone assembly 27, which is in turn interconnected by suitable means, such as welding or the like.

The completed end cone assembly 1 is then attached to the can portion of catalytic converter 2 by inserting the large end 19 of inner cone assembly 26 into the slot 40 in substrate support 4 and telescoping the large end 21 of outer cone assembly 27 over the exterior surface of housing member 3. The small end 14 of inner cone assembly 26 is positioned over the exterior surface of exhaust pipe 29. In the illustrated example, the circumferential weld 51 extends around both end edges of small ends 14, 16 and the exterior surface of exhaust pipe 29 to create an airtight seal therebetween. A circumferential weld 52 extends around the end edge of the large end 21 of outer cone assembly 27 and the exterior surface of housing member 3 to create an airtight seal therebetween. Resistance welding or the like may be used to connect the large end 19 of inner cone assembly 26 to substrate support 4 to create an airtight seal therebetween.

The insulating space 28 between inner and outer cone assemblies 26 and 27 thermally insulates the same to improve the performance of the associated catalytic converter. In at least one embodiment of the present invention, at least a partial vacuum is drawn in the insulating space 28 to better insulate inner cone assembly 26 from outer cone assembly 27.

The reference numeral 1a generally designates another embodiment of the present invention having a more dome-like shape than the end cone construction 1 illustrated in FIG. 1. Since end cone construction 1a is similar to the previously described end cone construction 1, similar parts appearing in FIGS. 1 and 2 respectively are represented by the same, corresponding reference numerals, except for the suffix “a” in the numerals of the latter. End cone construction 1a is somewhat shorter than end cone construction 1, such that the distance between exhaust pipe 29a and the can or housing member portion 3a of catalytic converter 2a is less than that in FIG. 1. Also, the shape of end cone construction 1a is more dome-like than the shape of end cone construction 1. More specifically, the sidewalls 22a and 24a of first inner and outer cone members 10a and 12a are more gently tapered, instead of the outwardly arcuate, flared configuration of end cone construction 1a. Furthermore, the sidewalls 23a and 25a of cone members 11a and 13a are formed with an arcuate measure of around 60 degrees. End cone construction 1a accommodates a more rapid or quick transition between exhaust pipe 29a and the housing member or can portion 3a of catalytic converter 2a. While end cone construction 1a is shown attached to the inlet portion of catalytic converter 2a, it is to be understood that the same may also be used on the opposite or outlet end of catalytic converter 2a.

The reference numeral 1b (FIG. 3) generally designates yet another embodiment of the present invention having a three-piece inlet end cone construction 1b. Since end cone construction 1b is similar to the previously described end cone constructions 1 and 1a, similar parts appearing in FIGS. 1-2 and 3 respectively are represented by the same, corresponding reference numerals, except for the suffix “b” in the numerals of the latter. In the example illustrated in FIG. 3, end cone construction 1b is attached to the inlet side of catalytic converter 2b. However, it is to be understood that end cone construction 1b may also be used on the outlet side of catalytic converter 2b.

End cone construction 1b includes first and second inner cone members 10b and 11b and first and second outer cone members 12b and 13b, similar to those described above, except for their shape and size. End cone construction 1b also includes third or intermediate inner and outer cone members 60 and 61 respectively. Intermediate cone members 60 and 61 are similar to the first inner and outer cone members 10b and 12b insofar as they include small ends 62 and 63, large ends 64 and 65, and continuous imperforate sidewalls 66 and 67 extending therebetween. Sockets 68 and 69, similar to sockets 35, 45, are formed at the large ends 64 and 65 of intermediate cone members 60 and 61, and receive the small ends 15b and 17b of second inner and outer cone members 11b and 13b therein. Circumferential welds 70 and 71, similar to welds 36, 46, are formed between the outer end edges of intermediate cone members 60 and 61 and the outer surfaces of second inner and outer cone members 11b and 13b respectively. In the three-piece end cone construction 1b, first inner and outer cones 10b and 12b are tapered at a relatively steep angle, and cone members 60-61 and 11b, 13b are gently arcuate in shape.

With reference to FIG. 3, the end cone construction 1c on the outlet side of catalytic converter 2b is identical to the end cone construction 1 (FIG. 1) shown on the inlet side of catalytic converter 2. Hence, similar parts appearing in FIGS. 1 and 3 respectively are represented by the same, corresponding reference numerals, except for the suffix “c” in the reference numerals of the latter. Since end cone constructions 1 and 1c are otherwise identical, additional description of end cone construction 1c is not necessary to an understanding of the present invention.

As noted above, the cone members 10-13, 10a-13a, 10b-13b, 10c-13c, and 60, 61 can be provided in a wide variety of different shapes and sizes to accommodate many different end cone applications. Furthermore, additional cones can be assembled in a manner similar to that disclosed above to form different links and/or shapes. Very complex shapes can be readily manufactured in a cost effective manner using this invention.

In the foregoing description, it will be readily appreciated by those skilled in the art that modifications may be made to the invention without departing from the concepts disclosed herein.

1. In a method for making catalytic converters and the like of the type having a housing member and a substrate support member, the improvement of a method for making a vacuum insulated end cap, comprising:
forming a first inner cone member from metal into a generally conoidal shape having a small end, a large end and a continuous imperforate sidewall extending therebetween;
forming a second inner cone member from metal into a generally conoidal shape having a small end, a large end and a continuous imperforate sidewall extending therebetween;
forming a first outer cone member from metal into a generally conoidal shape having a small end, a large end and a continuous imperforate sidewall extending therebetween;
forming a second outer cone member from metal into a generally conoidal shape having a small end, a large end and a continuous imperforate sidewall extending therebetween;
connecting the large end of the first inner cone with the small end of the second inner cone to create an airtight seal therebetween, and define an inner cone assembly;
connecting the large end of the first outer cone with the small end of the second outer cone to create an airtight seal therebetween, and define an outer cone assembly;
positioning the inner cone assembly concentrically within the outer cone assembly to define an insulating space therebetween having a substantially annular radial cross-sectional shape with a generally uniform width;
connecting the small end of the inner cone assembly with the small end of the outer cone assembly to create an airtight seal therebetween;
connecting the large end of the outer cone assembly with the housing member to create an airtight seal therebetween;
connecting the large end of the inner cone assembly with the substrate support member to create an airtight seal therebetween; and
drawing at least a partial vacuum in the insulating space to insulate the inner cone assembly from the outer cone assembly.

2. A method as set forth in claim 1, wherein:
said first inner cone member forming step comprises forming a radially enlarged socket at the large end of the first inner cone member to a size and shape which closely receive the small end of the second inner cone member therein.

3. A method as set forth in claim 2, wherein:
said connecting step for the inner cone assembly includes forming a circumferential weld around the free end of the socket and the outer surface of the second inner cone member adjacent the small end thereof to create the airtight seal.

4. A method as set forth in claim 3, wherein:
said first outer cone member forming step comprises forming a radially enlarged socket at the large end of the first outer cone member to a size and shape which closely receive the small end of the second outer cone member therein.

5. A method as set forth in claim 4, wherein:
said connecting step for the outer cone assembly includes forming a circumferential weld around the free end of the socket on the first outer cone member and the outer surface of the second outer cone member adjacent the small end thereof to create the airtight seal.

6. A method as set forth in claim 5, wherein:
said connecting step for attaching the large end of the inner cone assembly with the substrate support member comprises forming a circular groove in the end edge of the substrate support member and inserting the large end of the second inner cone member into the groove.

7. A method as set forth in claim 6, wherein:
said connecting step for attaching the large end of the outer cone assembly with the housing comprises inserting one end of the housing into the large end of the second outer cone member, and forming a circumferential weld around the second outer cone member and the housing to create the airtight seal.

8. A method as set forth in claim 7, wherein:
said first inner cone member forming step includes forming at least a portion of the inner cone member into a generally arcuate shape.

9. A method as set forth in claim 7, wherein:
said first inner cone member forming step includes forming at least a portion of the inner cone member into a generally frustruconical shape.

10. A method as set forth in claim 7, including:
forming the housing member from metal into a generally cylindrical shape.

11. A method as set forth in claim 10, including:
mounting a vacuum insulated end cap at both ends of the housing member.

12. A method as set forth in claim 1, wherein:
said connecting step for the inner cone assembly includes forming a circumferential weld around the free end of the socket and the outer surface of the second inner cone member adjacent the small end thereof to create the airtight seal.

13. A method as set forth in claim 1, wherein:
said first outer cone member forming step comprises forming a radially enlarged socket at the large end of the first outer cone member to a size and shape which closely receive the small end of the second outer cone member therein.

14. A method as set forth in claim 1, wherein:
said connecting step for the outer cone assembly includes forming a circumferential weld around the free end of the socket on the first outer cone member and the outer surface of the second outer cone member adjacent the small end thereof to create the airtight seal.

15. A method as set forth in claim 1, wherein:
said connecting step for attaching the large end of the inner cone assembly with the substrate support member comprises forming a circular groove in the end edge of the substrate support member and inserting the large end of the second inner cone member into the groove.

16. A method as set forth in claim 1, wherein:
said connecting step for attaching the large end of the outer cone assembly with the housing comprises inserting one end of the housing into the large end of the second outer cone member, and forming a circumferential weld around the second outer cone member and the housing to create the airtight seal.

17. A method as set forth in claim 1, wherein:
said first inner cone member forming step includes forming at least a portion of the inner cone member into a generally arcuate shape.

18. A method as set forth in claim 1, wherein:
said first inner cone member forming step includes forming at least a portion of the inner cone member into a generally frustruconical shape.

19. A method as set forth in claim 1, including:
forming the housing member from metal into a generally cylindrical shape.

20. A method for making vacuum insulated end caps for catalytic converters and the like of the type having a housing member and a substrate support member, comprising:
forming a first inner cone member from metal into a generally conoidal shape having a small end, a large end and a continuous imperforate sidewall extending therebetween;
forming a second inner cone member from metal into a generally conoidal shape having a small end, a large end and a continuous imperforate sidewall extending therebetween;
forming a first outer cone member from metal into a generally conoidal shape having a small end, a large end and a continuous imperforate sidewall extending therebetween;
forming a second outer cone member from metal into a generally conoidal shape having a small end, a large end and a continuous imperforate sidewall extending therebetween;
connecting the large end of the first inner cone with the small end of the second inner cone to create an airtight seal therebetween, and define an inner cone assembly with a large end thereof configured for attachment with the substrate support member to create an airtight seal therebetween;
connecting the large end of the first outer cone with the small end of the second outer cone to create an airtight seal therebetween, and define an outer cone assembly with a large end thereof configured for attachment with the housing to create an airtight seal therebetween;
positioning the inner cone assembly concentrically within the outer cone assembly to define an insulating space therebetween having a substantially annular radial cross-sectional shape with a generally uniform width;
connecting the small end of the inner cone assembly with the small end of the outer cone assembly to create an airtight seal therebetween; and
drawing at least a partial vacuum in the insulating space to insulate the inner cone assembly from the outer cone assembly.

21. A method as set forth in claim 20, wherein:
said first inner cone member forming step comprises forming a radially enlarged socket at the large end of the first inner cone member to a size and shape which closely receive the small end of the second inner cone member therein.

22. A method as set forth in claim 21, wherein:
said connecting step for the inner cone assembly includes forming a circumferential weld around the free end of the socket and the outer surface of the second inner cone member adjacent the small end thereof to create the airtight seal.

23. A method as set forth in claim 20, wherein:
said first outer cone member forming step comprises forming a radially enlarged socket at the large end of the first outer cone member to a size and shape which closely receive the small end of the second outer cone member therein.

24. A method as set forth in claim 23, wherein:
said connecting step for the outer cone assembly includes forming a circumferential weld around the free end of the socket on the first outer cone member and the outer surface of the second outer cone member adjacent the small end thereof to create the airtight seal.

25. In a catalytic converter of the type having a housing member and a substrate support member, the improvement of a vacuum insulated end cap, comprising:
a first inner cone member having a generally conoidal shape with a small end, a large end and a continuous imperforate sidewall extending therebetween;
a second inner cone member having a generally conoidal shape with a small end, a large end and a continuous imperforate sidewall extending therebetween; said large end of said first inner cone being connected with the small end of said second inner cone to create an airtight seal therebetween, and define an inner cone assembly;
a first outer cone member having a generally conoidal shape with a small end, a large end and a continuous imperforate sidewall extending therebetween;
a second outer cone member having a generally conoidal shape with a small end, a large end and a continuous imperforate sidewall extending therebetween; said large end of said first outer cone being connected with the small end of said second outer cone to create an airtight seal therebetween, and define an outer cone assembly; and
said inner cone assembly is disposed concentrically within said outer cone assembly to define an insulating space therebetween having a substantially annular radial cross-sectional shape with a generally uniform width, with the small end of said inner cone assembly being connected with the small end of said outer cone assembly to create an airtight seal therebetween, the large end of said outer cone assembly being connected with said housing member to create an airtight seal therebetween, the large end of said inner cone assembly being connected with said substrate support member to create an airtight seal therebetween, and said insulating space contains at least a partial vacuum to insulate said inner cone assembly from said outer cone assembly.

26. A catalytic converter as set forth in claim 25, wherein:
said first inner cone member includes a radially enlarged socket at the large end of said first inner cone member with a size and shape which closely receive the small end of said second inner cone member therein.

27. A catalytic converter as set forth in claim 26, wherein:
said inner cone assembly includes a circumferential weld around the free end of said socket and the outer surface of said second inner cone member adjacent the small end thereof to create said airtight seal.

28. A catalytic converter as set forth in claim 27, wherein:
said first outer cone member includes a radially enlarged socket at the large end of said first outer cone member with a size and shape which closely receive the small end of said second outer cone member therein.

29. A catalytic converter as set forth in claim 28, wherein:
said outer cone assembly includes a circumferential weld around the free end of said socket on said first outer cone member and the outer surface of said second outer cone member adjacent the small end thereof to create said airtight seal.

30. A catalytic converter as set forth in claim 29, wherein:
said substrate support member includes a circular groove in an end edge of said substrate support member in which the large end of said second inner cone member is received.

31. A catalytic converter as set forth in claim 30, wherein:
at least a portion of said first inner cone member has a generally arcuate shape.

32. A catalytic converter as set forth in claim 30, wherein:
at least a portion of said first inner cone member has a generally frustruconical shape.

33. In a method for making catalytic converters and the like of the type having a housing member and a substrate support member, the improvement of a method for making an end cap, comprising:
forming a first inner cone member from metal into a generally conoidal shape having a small end, a large end and a continuous imperforate sidewall extending therebetween;
forming a second inner cone member from metal into a generally conoidal shape having a small end, a large end and a continuous imperforate sidewall extending therebetween;
forming a third inner cone member from metal into a generally conoidal shape having a small end, a large end and a continuous imperforate sidewall extending therebetween;
forming a first outer cone member from metal into a generally conoidal shape having a small end, a large end and a continuous imperforate sidewall extending therebetween;
forming a second outer cone member from metal into a generally conoidal shape having a small end, a large end and a continuous imperforate sidewall extending therebetween;
forming a third outer cone member from metal into a generally conoidal shape having a small end, a large end and a continuous imperforate sidewall extending therebetween;
connecting the large end of the first inner cone with the small end of the second inner cone to create an airtight seal therebetween;
connecting the large end of the second inner cone with the small end of the third inner cone to create an airtight seal therebetween, and define an inner cone assembly;
connecting the large end of the first outer cone with the small end of the second outer cone to create an airtight seal therebetween;
connecting the large end of the second outer cone with the small end of the third outer cone to create an airtight seal therebetween, and define an outer cone assembly;
positioning the inner cone assembly concentrically within the outer cone assembly to define an insulating space therebetween having a substantially annular radial cross-sectional shape with a generally uniform width;
connecting the small end of the inner cone assembly with the small end of the outer cone assembly to create an airtight seal therebetween;
connecting the large end of the outer cone assembly with the housing member to create an airtight seal therebetween; and
connecting the large end of the inner cone assembly with the substrate support member to create an airtight seal therebetween.

34. A method as set forth in claim 33, including:
drawing at least a partial vacuum in the insulating space to insulate the inner cone assembly from the outer cone assembly.

35. In a method for making catalytic converters and the like of the type having a housing member and a substrate support member, the improvement of a method for making an end cap, comprising:
forming a first inner cone member from metal into a generally conoidal shape having a small end, a large end and a sidewall extending therebetween;
forming a second inner cone member from metal into a generally conoidal shape having a small end, a large end and a sidewall extending therebetween;
forming a first outer cone member from metal into a generally conoidal shape having a small end, a large end and a continuous imperforate sidewall extending therebetween;
forming a second outer cone member from metal into a generally conoidal shape having a small end, a large end and a continuous imperforate sidewall extending therebetween;
connecting the large end of the first inner cone with the small end of the second inner cone to define an inner cone assembly;
connecting the large end of the first outer cone with the small end of the second outer cone to create an airtight seal therebetween, and define an outer cone assembly;
positioning the inner cone assembly concentrically within the outer cone assembly to define an insulating space therebetween having a substantially annular radial cross-sectional shape with a generally uniform width;
connecting the small end of the inner cone assembly with the small end of the outer cone assembly;
connecting the large end of the outer cone assembly with the housing member to create an airtight seal therebetween; and
connecting the large end of the inner cone assembly with the substrate support member.

36. A method as set forth in claim 35, including:
positioning insulation means in the insulating space.

37. A method as set forth in claim 36, wherein:
said first outer cone member forming step comprises forming a radially enlarged socket at the large end of the first outer cone member to a size and shape which closely receive the small end of the second outer cone member therein.

38. A method as set forth in claim 37, wherein:
said connecting step for the outer cone assembly includes forming a circumferential weld around the free end of the socket on the first outer cone member and the outer surface of the second outer cone member adjacent the small end thereof to create the airtight seal.

39. A method as set forth in claim 38, wherein:
said connecting step for attaching the large end of the inner cone assembly with the substrate support member comprises forming a circular groove in the end edge of the substrate support member and inserting the large end of the second inner cone member into the groove.

40. A method as set forth in claim 39, wherein:
said first inner cone member forming step includes forming at least a portion of the inner cone member into a generally arcuate shape.

41. A method as set forth in claim 39, wherein:
said first inner cone member forming step includes forming at least a portion of the inner cone member into a generally frustruconical shape.
